(19) United States
(12) Patent Application Publication
(10) Pub. No.: US 2022/0214045 A1
(43) Pub. Date: Jul. 7, 2022

(54) METHOD OF HANDLING WOOD FUEL PELLETS

(71) Applicant: W.C. BRADLEY CO., Columbus, GA (US)

(72) Inventors: GUNJIT KUMAR, Newnan, GA (US); THOMAS H. WARD, CATAULA, GA (US); DAN CORSO, Columbus, GA (US); Ryan Sterritt, Opelika, AL (US); SCOTT LAWRENCE WAYLAND, Columbus, GA (US)

(21) Appl. No.: 17/143,680

(22) Filed: Jan. 7, 2021

(51) Int. Cl. F24B 13/02; A47J 37/07

(52) U.S. Cl. CPC F24B 13/02; A47J 37/0786

(57) ABSTRACT

A filter insert is sized to fit into a fuel pellet handling bucket and has a filter floor elevated by a plurality of standoffs to define a space below the screen mesh fuel insert.

### FIELD OF THE INVENTION

This disclosure relates to fuel handling operations in general and, more specifically, to fuel handling operations for pellet fueled cooking devices.

### BACKGROUND OF THE INVENTION

Compressed wood fuel pellets are used in a variety of applications including heating and cooking. For either mobile or stationery applications it may be desirable to handle pellets in buckets instead of directly from a bag. One issue that arises in handling wood pellets is that the mechanical action of pellets on each other in the act of moving them tends to grind small particles of wood dust off the surface of the pellets. This fine dust has a strong affinity to combine with water vapor in the air or stray droplets of water and create a glue like paste that severely impedes the movement of the pellets through the auger systems typically used to transport them and, can cause component failure or downtime due to necessary repairs.

What is needed is a system and method for addressing the above and related concerns.

### SUMMARY OF THE INVENTION

The invention of the present disclosure, in one aspect thereof, comprises a fuel pellet handling system including a filter insert sized to fit into a fuel pellet handling bucket. The filter insert comprises a filter floor elevated by a plurality of standoffs to define a space below the screen mesh fuel insert. The filter floor defines openings allowing dust to pass therethrough but retaining fuel pellets.

In some embodiments, the filter floor comprises a screen mesh. The filter insert may further comprise an upright wall extending from the filter floor. The upright wall may comprise a screen mesh. The upright wall may comprise four screen mesh panels arranged in a rectilinear configuration extending upwardly from the filter floor.

The filter insert may include a pair of handles joined to the upright wall. Each of the pair of handles may be joined to a different one of the four screen mesh panels.

In some embodiments, a lower frame is situated at a perimeter of the floor and joined to the plurality of standoffs. An upper frame may be situated an upper perimeter of the four upright planar screen mesh walls and joining the pair of handles to the upright wall.

In invention of the present disclosure, in another aspect thereof, comprises a fuel pellet handling system having a screen mesh floor, four upright screen wall panels arranged in a slab sided configuration and joined to the floor to define an interior volume for storing fuel pellets, and a plurality of standoffs elevated the screen mesh floor to define a space below the screen mesh floor. The screen mesh floor and the screen wall panels retain fuel pellets in the interior volume while allowing particles below a predetermined size to pass through.

Some embodiments further comprise a lower frame having a frame rail at a junction of each of the four upright screen wall panels and the screen mesh floor. The plurality of standoffs may be affixed to the lower frame.

Some embodiments further comprise an upper frame joined to the four upright screen walls panels at an opposite end thereof from the screen mesh floor, the upper frame providing a plurality of handles extending upwardly therefrom. The upper frame may comprise four frame rails, with one of each of the frame rail joined to one of the four upright screen walls.

In some embodiments, each of the plurality of handles joins to a single frame rail of the upper frame. In other embodiments, each of the plurality of handles joins to two of the frame rails of the upper frame.

The invention of the present disclosure, in another aspect thereof, comprises a fuel pellet handling system including a fuel pellet bucket having an interior volume of a first contour, an open top, and a floor, and a screen mesh insert sized to fit within the interior volume and having a second contour corresponding to the first contour. The mesh screen insert has a mesh screen floor elevated above the pellet bucket floor by at least one standoff such that a void is defined between the mesh screen floor and the bucket floor.

The mesh screen insert may have at least one handle affixed on a top thereof. The handle of the mesh screen insert may be rotatable between an extended position and a lowered position. The handle may span an opening into the screen mesh insert. In some cases, a lid fits onto the pellet fuel bucket.

### BRIEF DESCRIPTION OF THE DRAWINGS

FIG. 1 is a perspective view of one embodiment of a filter insert for a pellet handling system according to aspects of the present disclosure.

FIG. 2 is an exploded perspective view of a pellet handling system according to aspects of the present disclosure.

FIG. 3 is a perspective view of another embodiment of a filter insert for a pellet handling system according to aspects of the present disclosure.

FIG. 4 is a perspective view of another embodiment of a filter insert for a pellet handling system according to aspects of the present disclosure.

FIG. 5 is an exploded perspective view of another embodiment of a filter insert for a pellet handling system according to aspects of the present disclosure.

### DETAILED DESCRIPTION OF THE PREFERRED EMBODIMENTS

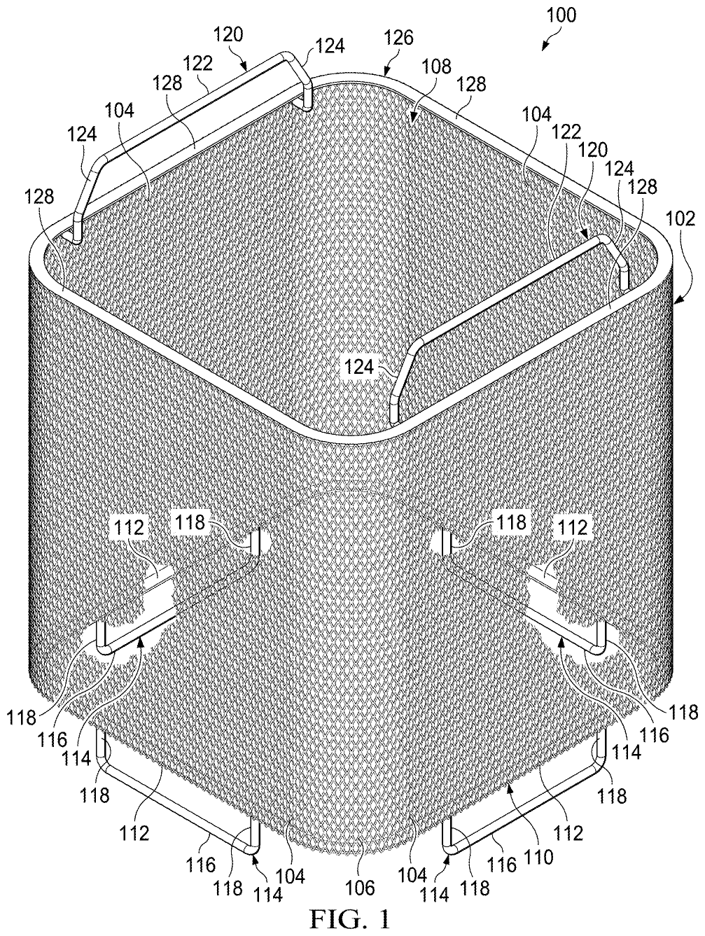

Referring now to FIG. 1, a perspective view of one embodiment of a filter insert 100 for a pellet handling system according to aspects of the present disclosure is shown. In various embodiments, the present disclosure provides a screen wire basket as a filter insert 100 that acts as an inner liner for a bucket used for transporting fuel pellets. The insert 100 may be generally rectilinear in appearance and shape, or may have other shapes that conform to the bucket or container in which it is utilized.

In the illustrated embodiment of FIG. 1, the insert 100 comprises a wall 102 comprising four panels 104. The panels 104 may be generally planar but may be rounded or radiused where they join together. In some embodiments, the panels 104 and the wall 102 may be a continuous piece of material with no seams. In other embodiments, one or more of the panels 104 may be formed separately and joined together. The wall 102 may comprise a wire screen material or a planar material than is bent to the appropriate shape and perforated (before or after bending).

The wall 102 may be constructed such that openings therein allow dust and other fine material to pass through while retaining all or a majority of the useable fuel pellets. In various embodiments, openings or apertures in the wall 102 may range from 0.5 mm up 5 mm. In other embodiments, openings or apertures may range from large enough to effectively pass dust particles but small enough to prevent passage of most or all intact fuel pellets.

A floor 106 may be provided for the insert 100 near a bottom end thereof. The floor 106 and wall 102 define an interior volume 108 in which fuel pellets are received, transported, etc., but which will allow dust and other fine materials to pass or fall through. To that end, the floor 106 may comprise a wire screen, mesh, or perforated material similar to the wall 102. The floor may be a planar component affixed to a lower portion of the wall 102.

In some embodiments, the floor 106 may be formed as a separate component from the wall 102 and then attached thereto. A lower frame 110 may bound the floor 106 and or the lower wall 102. The lower frame 110 may interconnect the wall 102 and the floor 106 and may provide structural rigidity. In the present embodiment, the floor 106 is generally square, though it may have radiused corners to match the panels 104 of the wall 102. The lower frame 110 may comprise a number of rails 112 joined together with each rail 110 aligning with a conjunction of a wall panel 104 and one side of the floor 106. The joints of adjacent frame rails 112 may be radiused to match the wall panels 104 and/or floor 106. The lower frame 110 may comprise a wire or metallic material. It may affix to the wall 102 and/or floor 106 via welding, use of an adhesive, or other mechanisms.

Rather than resting directly on a container floor, the insert 100 may provide one or more standoffs 114 projecting downwardly from the wall panels 104, floor 106, or, as illustrated, from the rails 112 of the frame 110. The standoffs 114 may comprise a lower rail or foot 116 suspended by spaced apart legs 118. In other embodiments other structures or configurations may be utilized that allow the floor 106 to be elevated above a container floor into which the insert 100 is placed.

The insert 100 may also provide handles, such as illustrated handles 120, that allow the insert to be moved or inserted and removed from the pellet container. A top portion of the wall 102 may be affixed to a top frame 126. The top frame 126 may have four rails 128 joined in a square configuration (possibly radiused at the corners). One rail 128 may be situated atop each of the four wall panels 104. The top frame may provide mounting locations for the handles 120.

The handles 120 may comprise a grip 122 suspended over the frame rail 128 by a pair of spaced apart arms 124. The arms 124 may angle inward toward the grip 122 in some embodiments. As shown, there are two handles 120 located on two opposite frame rails 128. Four or more handles 120 may be provided but two are sufficient for stable lifting and movement of the insert 100.

The insert 100 may also be said to have a contour conforming to an interior of the bucket 200 such that the interior volume 108 of the insert 100 is nearly the same as the interior volume 209 of the bucket 202. In some embodiments, the loss of interior volume 108 of the insert 100 relative to the interior volume 209 of the bucket 202 is due only to the necessity of the wall 102 of the insert 100 to fit within the walls 204 of the bucket 202 and due to the wall 102 of the insert 100 being somewhat shorter than the walls 204 of the bucket 202 due to the standoffs 114 and/or handles 120 of the insert 100.

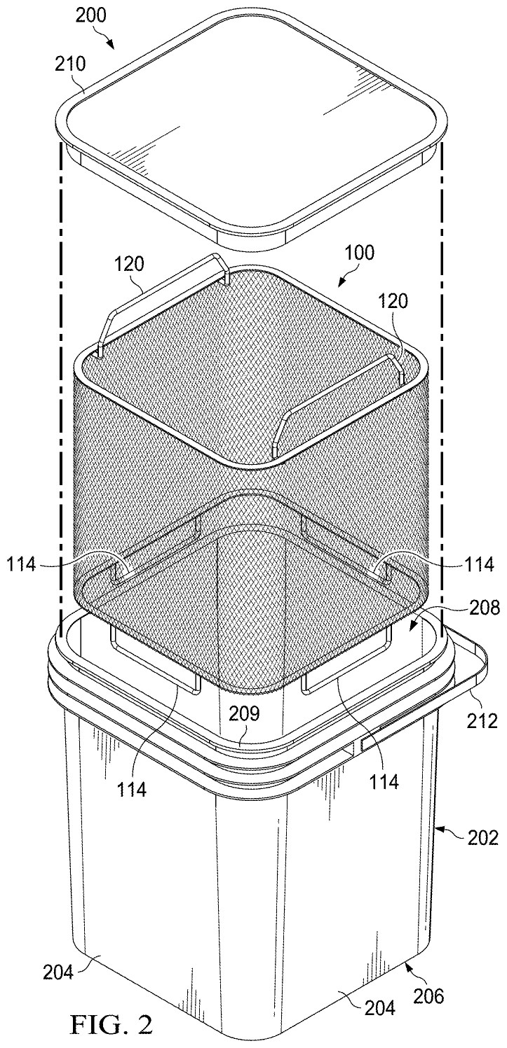

Referring now to FIG. 2, an exploded perspective view of a pellet handling system 200 according to aspects of the present disclosure is shown. FIG. 2 illustrates one possible application of the insert 100 described above. The insert 100 may comprise a screen wire basket is somewhat smaller in dimension from a transport bucket 202 with which it may be used to transport and handle pellet fuel. The screen wire is sized to retain normal commercial pellets but allow dust to pass. As noted above, perforated sheets or other arrangements may be used to retain pellets but pass dust.

The insert 100 may be placed into the bucket 202 and rest on a floor 206 thereof. The bucket 202 may comprise a square or rectilinear shape with four walls 204 ascending from the floor. In some embodiments the bucket 212 may have a handle for transport or other uses. A tight-fitting lid 210 may also be provided. The lid 210 may fit tightly onto or seal onto an upper lip 209 of the bucket 202 with the insert (possibly containing fuel pellets) covered in an interior 208 of the bucket 202. The bucket 202 may have other features making it compatible with particular pellet hoppers and other fuel handling equipment.

The standoffs 114 define a space between the floor 206 of the transport bucket 202 and the floor 106 of the insert 100. In use, the transport bucket 202 with the insert 100 inside can be placed below the hopper of a pellet grill and catch fuel pellets as they are drained from the hoper. With the tight-fitting lid 210 the entire system 200 pellets can be stored until the next use event. At that point the insert 100 may be removed from the transport bucket 202 and the fuel pellets poured into the hopper. Dust or contaminants in the fuel pellets will tend to collect below the insert floor 106 and can be discarded.

The bucket 202 may be a vertically extended configuration of any closed cross section (such as an oval, rectangle, or triangle or any generalized closed section). The insert 100 may have a shape that conforms to the internal dimensions of the bucket 202 in that it fits inside the bucket 202 possibly mirroring the shape for maximum capacity for the bucket 202.

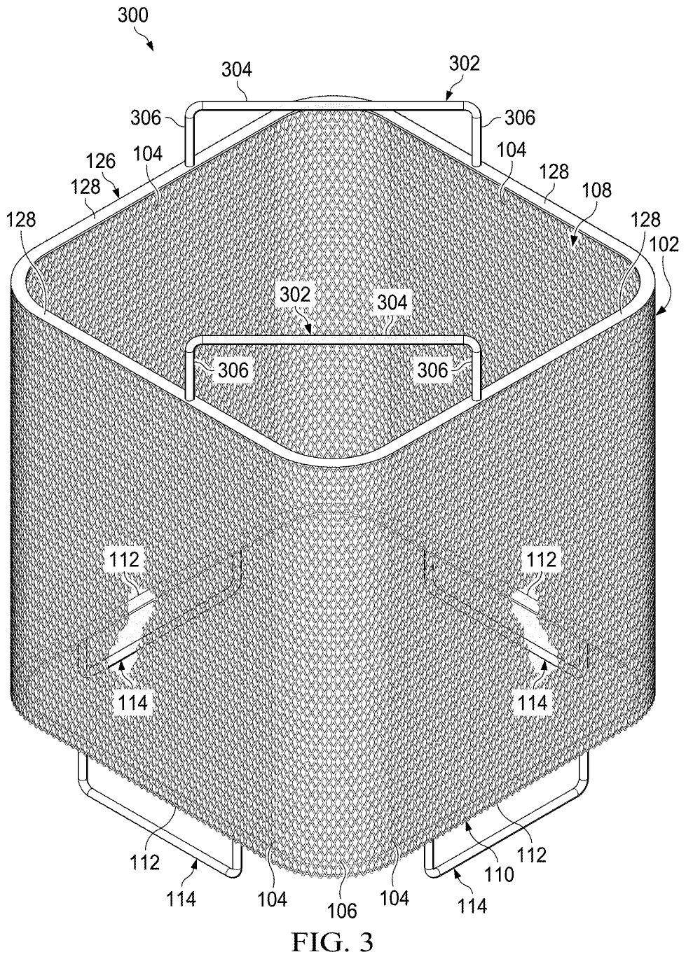

Referring now to FIG. 3 is a perspective view of another embodiment of a filter insert 300 for a pellet handling system according to aspects of the present disclosure. The insert 300 is substantially similar or identical to the insert 100 with exceptions noted. It may also be used in the same or a similar way within the system 200 as the insert 100. Here, handles 302 comprise grips 304 suspended above and attached to the upper frame 126 via legs 306. The legs 306 are spaced apart but each is affixed to a separate frame rail 128. Thus the grips 304 are somewhat suspended over the interior volume 108 of the insert 300. The grips 304 are considered offset by about 45 degrees from the rails 128. The handles 302, in the configuration shown, allow for different options for pouring and manipulating the insert 300 but otherwise fulfill the function of the handles 120 discussed above (e.g., movement and manipulation of the insert 300 in or out of the associated bucket 200).

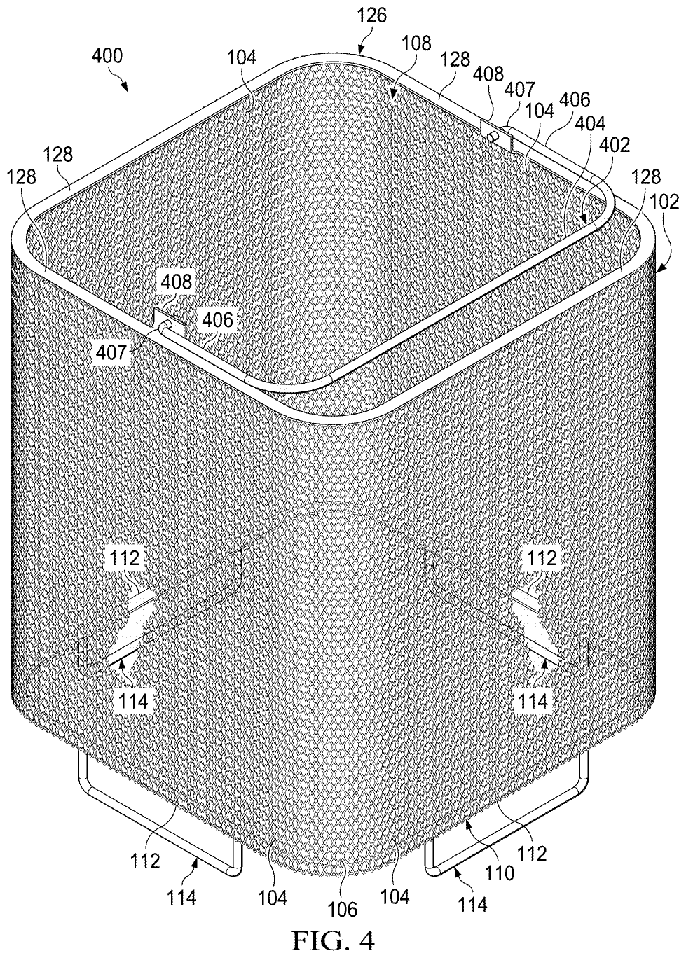

Referring now to FIG. 4, a perspective view of another embodiment of a filter insert 400 for a pellet handling system according to aspects of the present disclosure is shown. The insert 400 is substantially similar or identical to the insert 100 with exceptions noted. It may also be used in the same or a similar way within the system 200 as the insert 100. The insert 400 comprises a handle 402 with a grip 404 attached via spaced apart arms 406 into tabs 408 at inward bends 407. The tabs 408 may be affixed to a pair of opposite wall panels 104 of the wall 102 and/or to top frame 406 on opposite rails 128. The handle 402 operates similarly to a bucket handle and may lay down on or over the wall 102 of the insert 400 when not in use. The handle 402 may be used to lift or move the insert 400 and/or to aid in emptying or pouring out contents (fuel pellets) from the insert 400. In use, a user may grip a lower portion of the insert 400 to empty or pour its contents (e.g., gripping at the offset 114 and the handle 402).

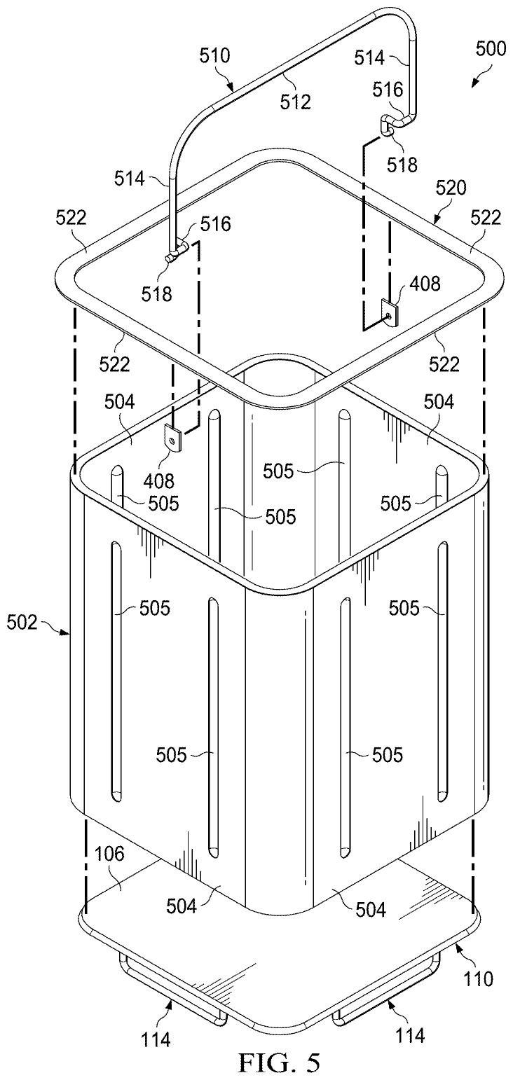

Referring now to FIG. 5 an exploded perspective view of another embodiment of a filter insert 500 for a pellet handling system according to aspects of the present disclosure is shown. The insert 400 is substantially similar or identical to the insert 100 with exceptions noted. It may also be used in the same or a similar way within the system 200 as the insert 100.

A wall 502 of the insert 500 may comprise four wall panels 504. These may be integral components or may be formed separately and joined together. The wall panels 504 may be planar or substantially planar and may be joined to one another with a radius eliminating a sharp corner and conforming, for example, to radiused corners of lower frame 110 and/or floor 106. Like the wall 102, the wall 502 may comprise a wire screen or mesh material. It may also comprise a solid sheet of material that has been perforated such that dust and impurities may pass through while pelletized fuel is retained. The panels 504 may also comprise bends, folds, impressions, or other features to enhance stiffness or rigidity. Here, embossments 505 run vertically along the panels 504. Two spaced apart vertical embossments 505 are provided on each panel 504 in the illustrated embodiments, but other configurations may be employed. The embossments 505 are not configured to substantially alter the interior volume of the insert 500, nor to alter the ability of the panels 504 to retain fuel pellets but pass dust and impurities.

The insert 500 comprises an upper lip 520 in place of upper frame 126 (FIG. 1). The upper lip 520 may comprise four rails 522 joined or formed into a square configuration or other configuration as may fit the top of the wall 502 (corners may be radiused, as with other components). Tabs 408 may be affixed to the lip 520 on a pair of opposite rails 522 and provide a mounting location for a handle 510. Handle 510 may comprise a grip 510 having spaced apart arms 514 extending therefrom toward the tabs 408. Insets 516 may extend inwardly from the arms (e.g., toward a center line of the handle 510 or insert 500) and locate hooks 518 for insertion into tabs 408. The insets 516 allow the handle 510 to lie flat on the lip 520 while no part of the handle 510 extends laterally beyond the lip 520 and/or wall 520.

The wall 502, floor 106 with frame 110, and lip 520 may be joined together with adhesives, welds, or other means as known in the art, in a similar or identical manner to the components of the inserts 100, 300, 400 discussed above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A fuel pellet handling system comprising:
a filter insert sized to fit into a fuel pellet handling bucket;
wherein the filter insert comprises a filter floor elevated by a plurality of standoffs to define a space below the screen mesh fuel insert; and
wherein the filter floor defines openings allowing dust to pass therethrough but retaining fuel pellets.

2. The fuel pellet handling system of claim 1, wherein the filter floor comprises a screen mesh.

3. The fuel pellet handling mechanism of claim 2, wherein the filter insert further comprises an upright wall extending from the filter floor.

4. The fuel pellet handling mechanism of claim 3, wherein the upright wall comprises a screen mesh.

5. The fuel pellet handling mechanism of claim 4, wherein the upright wall comprises four screen mesh panels arranged in a rectilinear configuration extending upwardly from the filter floor.

6. The fuel pellet handling system of claim 5, wherein the filter insert further comprises a pair of handles joined to the upright wall.

7. The pellet handling system of claim 6, wherein each of the pair of handles is joined to a different one of the four screen mesh panels.

8. The pellet handling system of claim 6, further comprising a lower frame at a perimeter of the floor and joined to the plurality of standoffs.

9. The pellet handling system of claim 8, further comprising an upper frame at an upper perimeter of the four upright planar screen mesh walls and joining the pair of handles to the upright wall.

10. A fuel pellet handling system comprising:
a screen mesh floor;
four upright screen wall panels arranged in a slab-sided configuration and joined to the floor to define an interior volume for storing fuel pellets; and
a plurality of standoffs elevated the screen mesh floor to define a space below the screen mesh floor;
wherein the screen mesh floor and the screen wall panels retain fuel pellets in the interior volume while allowing particles below a predetermined size to pass through.

11. The pellet handling system of claim 10, further comprising a lower frame having a frame rail at a junction of each of the four upright screen wall panels and the screen mesh floor.

12. The pellet handling system of claim 11, wherein the plurality of standoffs are affixed to the lower frame.

13. The pellet handling system of claim 12, further comprising an upper frame joined to the four upright screen walls panels at an opposite end thereof from the screen mesh floor, the upper frame providing a plurality of handles extending upwardly therefrom.

14. The pellet handling system of claim 13, wherein the upper frame comprises four frame rails, with one of each of the frame rail joined to one of the four upright screen walls.

14. The pellet handling system of claim 14, wherein each of the plurality of handles joins to a single frame rail of the upper frame.

15. The pellet handling system of claim 14, wherein each of the plurality of handles joins to two of the frame rails of the upper frame.

16. A fuel pellet handling system comprising:
a fuel pellet bucket having an interior volume of a first contour, an open top, and a floor; and
a screen mesh insert sized to fit within the interior volume and having a second contour corresponding to the first contour;
wherein the mesh screen insert has a mesh screen floor elevated above the pellet bucket floor by at least one standoff such that a void is defined between the mesh screen floor and the bucket floor.

17. The fuel pellet handling system of claim 16, wherein the mesh screen insert has at least one handle affixed on a top thereof.

18. The fuel pellet handling system of claim 17, wherein the handle of the mesh screen insert is rotatable between an extended position and a lowered position.

19. The fuel pellet handling system of claim 17, further comprising a lid fitting onto the fuel pellet bucket.

20. The fuel pellet handling system of claim 17, wherein the at least one handle spans an opening into the mesh screen insert.
